(19) United States
(12) Patent Application Publication
(10) Pub. No.: US 2017/0315347 A1
(43) Pub. Date: Nov. 2, 2017

(54) Exit Pupil Expander for Laser-Scanner and Waveguide Based Augmented-Reality Displays

(71) Applicants: Mikko Antton Juhola, Muurla (FI); Jani Kari Tapio Tervo, Espoo (FI); Tuomas Heikki Vallius, Espoo (FI)

(72) Inventors: Mikko Antton Juhola, Muurla (FI); Jani Kari Tapio Tervo, Espoo (FI); Tuomas Heikki Vallius, Espoo (FI)

(21) Appl. No.: 15/142,358

(22) Filed: Apr. 29, 2016

(51) Int. Cl. G02B 27/00; G02B 3/00; F21V 8/00; G02B 13/18; G02B 27/01

(52) U.S. Cl. CPC G02B 27/0081; G02B 13/18; G02B 27/0172; G02B 3/0006; G02B 6/003; G02B 2027/0123

(57) ABSTRACT

Lightweight, compact, and cost-efficient solutions for increasing the exit pupil size for use in laser-scanner and waveguide based augmented-reality displays are disclosed. Light from a laser-scanner is focused onto intermediate image plane; a diffuser is positioned at the intermediate image plane to steer light efficiently in a desired direction; the pupil is then expanded with a lens assembly; the lens assembly can contain one or more aspherical and/or free-form optics; the output of the lens assembly can then act as the input to a waveguide plate or stack; and the result is a large field-of-view image with sufficiently large exit pupil to overcome/reduce the pupil-replication problem.

### BACKGROUND

### Background and Relevant Art

In waveguide-based augmented or virtual-reality displays, the virtual content is typically created using conventional optics. This causes serious problems with size, weight, and power consumption when large field of views are desired, which will be the goal in the near future. To reduce the size and weight, and increase the power efficiency, laser-scanner based display modules are considered as one potential solution.

One of the main obstacles with such an approach is the pupil-replication problem. Because the beam (exit pupil of the display module) size is typically in the order of 1 mm and because the light is highly monochromatic, the virtual image as seen by an observer will likely contain bright and dark regions, which can be unpleasant and can compromise the virtual image quality. In addition, with an exit pupil of 1 mm, it is not possible to achieve a level of angular separation necessary to achieve the desired resolution and field of view of an augmented-reality display. Increasing the exit pupil to 3.5 mm can dramatically improve the situation, although other means to further improve the image quality may still be required. Unfortunately, achieving such a large exit pupil size with a lightweight, compact, and cost-efficient solution do not currently exist.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The invention is generally directed to lightweight, compact, and cost-efficient solutions for increasing the exit pupil size for use in laser-scanner and waveguide based augmented-reality displays. According to one embodiment, light from a laser-scanner is focused onto intermediate image plane; a diffuser is positioned at the intermediate image plane to steer light efficiently in the desired direction; the pupil is then expanded with a lens assembly; the lens assembly can contain one or more aspherical and/or free-form optics; the output of the lens assembly can then acts as the input to a waveguide plate or stack; and the result is a large field-of-view image with sufficiently large exit pupil to overcome/reduce the pupil-replication problem.

An embodiment is directed to an optical display apparatus for laser-scanner and waveguide based displays configured to increase the exit pupil of the optical display apparatus. The apparatus can have a laser-based scanner having a first exit pupil size, wherein the laser-based scanner is focused onto an intermediate image plane. The apparatus can also include a diffuser positioned at the intermediate image plane, the diffuser comprising a plurality of pixels to receive input laser light from the laser-based scanner, wherein each pixel can convert the input laser light received by that pixel into a secondary point source and steers output light emerging from the diffuser from each secondary point source towards a particular exit angle and having a particular conical angle. The apparatus can also have a lens assembly for forming light generated by the laser-based scanner. The lens assembly can have an input end for receiving output light emerging from the diffuser, an output end forming a second exit pupil having a second exit pupil size larger than the first exit pupil size, and one or more optical lenses positioned between the input end and the output end. The lens assembly can also be positioned relative to the diffuser and be configured such that the output light emerging from each secondary point source is distributed over substantially the entire second exit pupil, and produces at the output end of the lens assembly a collimated beam of the second exit pupil size. Carefully steering the light from each pixel/secondary point source on the diffuser 22 and projecting it across the entire area of the second exit pupil 30 optimizes the optics and provides the best possible efficiency.

Other embodiments can include methods that may be practiced for increasing the exit pupil size for use in laser-scanner and waveguide based augmented-reality displays. In one such embodiment, the method includes acts for increasing the exit pupil of a laser-scanner and waveguide based display. The method can include an act for focusing a laser-based scanner having a first exit pupil size onto an intermediate image plane. The method can also include an act for positioning at the intermediate image plane a diffuser comprising a plurality of pixels to receive input laser light from the laser-based scanner. The method can further include an act for converting by the diffuser the input laser light received by each pixel into a secondary point source and steering output light emerging from the diffuser from each secondary point source towards a particular exit angle and having a particular conical angle. The method can also include an act for receiving output light emerging from the diffuser by a lens assembly, the lens assembly having an input end, an output end, and one or more optical lenses positioned between the input end and the output end. And the method can include an act for forming at the output end of the lens assembly a second exit pupil having a second exit pupil size larger than the first exit pupil size, wherein the lens assembly is positioned relative to the diffuser and is configured such that the output light emerging from each secondary point source is distributed over substantially the entire second exit pupil, and produces at the output end of the lens asset b a collimated beam of the second exit pupil size.

This Summary is provided to introduce a selection of concepts in a simplified form that are further described below in the Detailed Description, This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter,

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 is a schematic representation of an exit pupil expander for laser-scanner and waveguide based augmented-reality displays.

FIG. 2A is a cross-sectional view of one embodiment of a lens assembly for expanding the exit pupil in a laser-scanner and waveguide based augmented-reality display, schematically illustrating a light beam emerging from a first pixel of a diffuser or micro-lens array.

FIG. 2B is a cross-sectional view of one embodiment of a lens assembly for expanding the exit pupil in a laser-scanner and waveguide based augmented-reality display, schematically illustrating a light beam emerging from another pixel of the diffuser or micro-lens array.

FIG. 2C is a cross-sectional view of one embodiment of a lens assembly for expanding the exit pupil in a laser-scanner and waveguide based augmented-reality display, schematically illustrating a light beam emerging from yet another pixel of the diffuser or micro-lens array.

FIG. 3 is a cross-sectional view of another embodiment of a lens assembly for expanding the exit pupil in a laser-scanner and waveguide based augmented-reality display.

FIG. 4 is a schematic representation of an augmented-reality display incorporating an exit pupil expander as described herein.

FIG. 5 is a block diagram of one embodiment of a method for expanding the exit pupil in a laser-scanner and waveguide based augmented-reality display.

### DETAILED DESCRIPTION

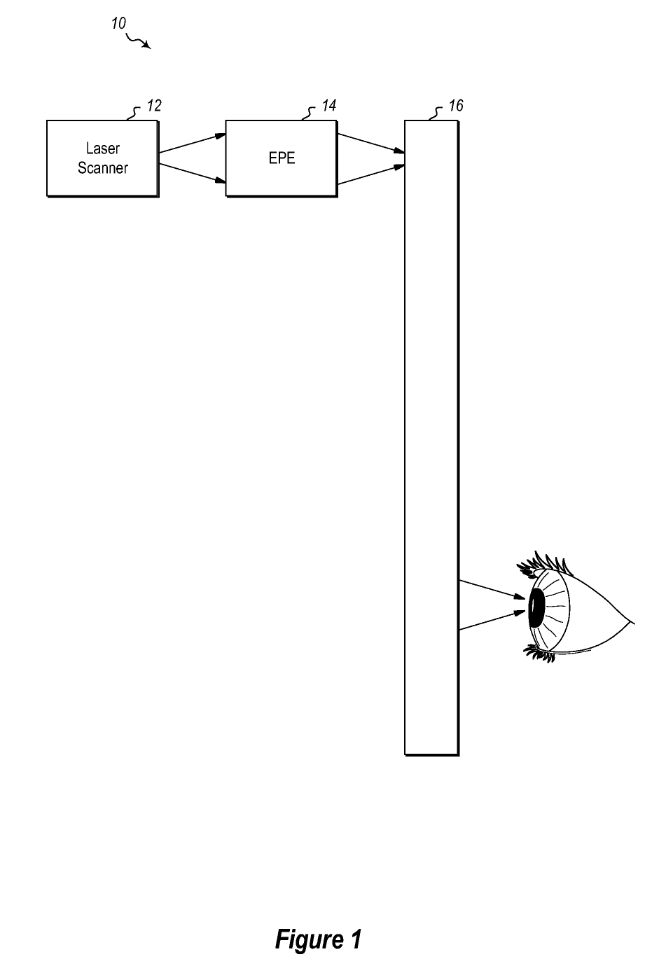

Referring to FIG. 1, a virtual display device 10 may comprise a laser-based scanner 12, an exit pupil expander 14 and waveguide 16. The laser-based scanner 12 forms a virtual image for viewing by a user. Use of a laser-based scanner 12 is useful in terms of its small size and weight However, as mentioned above, the exit pupil of laser-based scanners may range from about 0.5 to about 2 millimeters, but are typically on the order of 1 millimeter. And, when a laser-based scanner is combined with a waveguide plate or stack to create an augmented-reality display, such a small exit pupil size poses significant limitations in terms of resolution and overall image quality. Therefore, there is a need to expand the exit pupil from about 1 millimeter to at least about 3.5 millimeters to overcome the aforementioned limitations. In addition, the exit pupil expander should be relatively lightweight, inexpensive and capable of accurate replication during mass production,

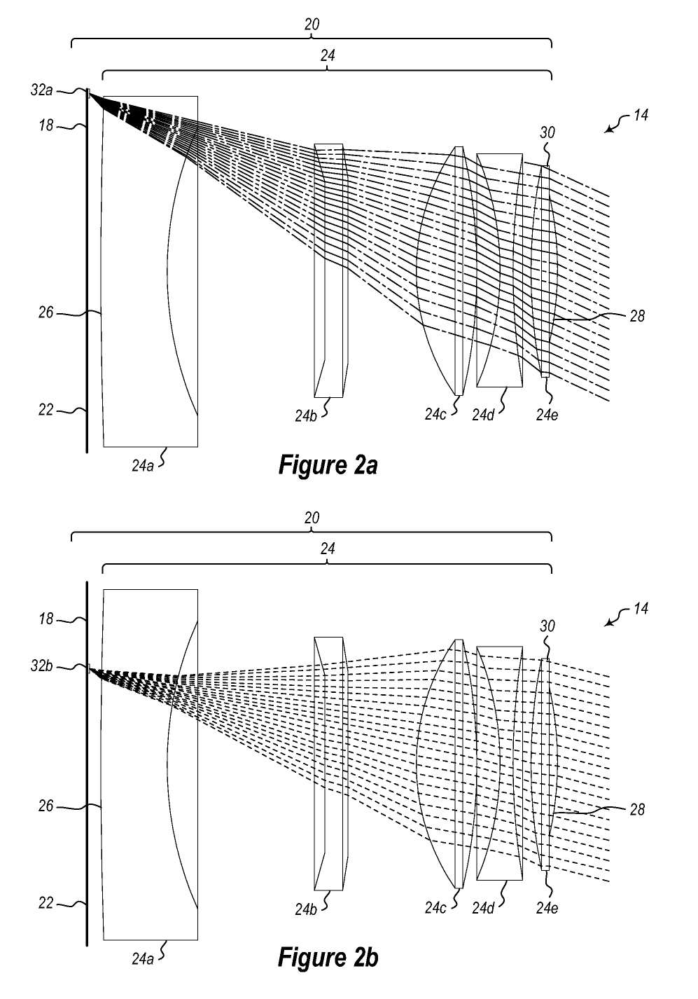

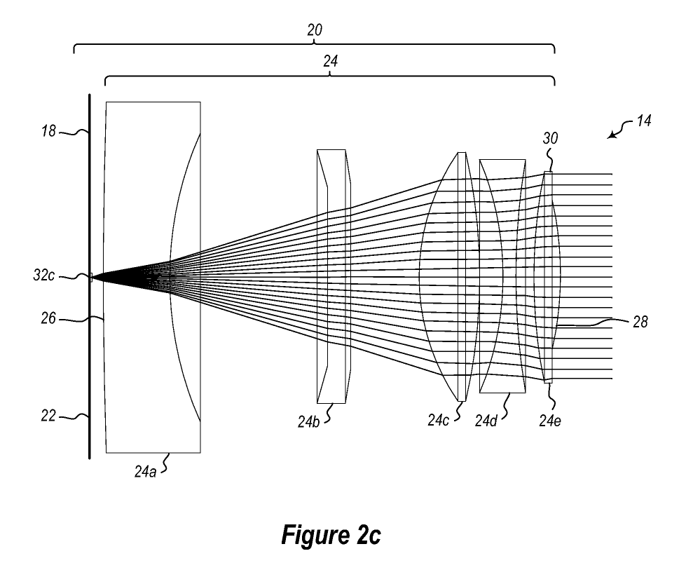

Referring to FIG. 2A, exit pupil expander 14 can include a diffuser 2 and one or more optical elements making up a lens assembly 24. Lens assembly 24 can include an input end 26 for receiving output light emerging from diffuser 22, an output end 28 forming a second exit pupil 30 having an exit pupil size of about 3 to about 3.5 millimeters, and one or more optical lenses 24a-e positioned between input end 26 and output end 28. Optical elements or lenses 24a-e are shown for illustration purposes; the specific number and configuration of lenses 24a-e are selected to achieve the properties discussed below.

The light from the laser scanner 12 is focused onto an intermediate image plane, generally designated as 18 in FIG. 2A. Diffuser 22 is positioned at intermediate image plane 20. A focused spot scans across the exit pupil expander 14 and produces multiple diffraction orders at the exit pupil, where each diffraction order contains the full image information. The eye pupil samples a few of such diffraction orders and forms a retinal image. Overall luminance and color uniformity across the exit pupil perceived by the viewer is a function of the uniformity of the diffraction order relative intensities, focused spot size, diffuser diameter, scanning beam profile, and the viewer's eye-pupil size.

Diffuser 22 can include a plurality of pixels to receive input laser light from laser-based scanner 12. As schematically illustrated in FIGS. 2A-C, the scanning beam from laser-scanner can be focused so as to impinge on individual pixels of diffuser 22. Laser-scanner 12 produces an image by scanning across the surface of the intermediate image plane 20, such that only one pixel on diffuser 22 will be illuminated by the laser-scanner at a given point in time. One such pixel 32a is schematically illustrated in FIG. 2A, a different pixel 32b illuminated at a different point in time is schematically illustrated in FIG. 2B, and a third pixel 32c illuminated at yet a third point in time is schematically illustrated in FIG. 2C. In addition, diffuser 22 can also include structures to reduce or minimize cross-talk between adjacent pixels.

Each pixel located on diffuser 22 converts the input laser light received by that pixel into a secondary point source and steers output light emerging from diffuser 22 from each such secondary point source towards a particular exit angle having a particular conical angle, as schematically illustrated in FIGS. 2A-2C. In addition, although the output light emerging from diffuser 22 is schematically illustrated only in two dimensions in FIGS. 2A-2C, the output light emerging from each secondary point source actually forms a three-dimensional cone that is substantially symmetrical about the propagation axis.

Diffuser 22 is fabricated having a geometry such that each pixel is formed so that the output light emerging from that pixel is steered towards a certain exit angle and conical angle. The exit angle and conical angle of each pixel should be selected so as to, when combined with the lens assembly, project the output light emerging from that pixel/secondary point source across substantially the entire cross-sectional area of the second exit pupil 30 located at the output end 28 of the lens assembly 24.

In the illustrated embodiment, intermediate image plane 20 and diffuser 22 measure approximately 6.2 millimeters diagonally, but can generally be in a range of about 5 to about 10 millimeters, Intermediate image plane 20 and diffuser 22 can include about 2,000 pixels in the diagonal direction, with each pixel being approximately 3 microns in size, but the number of pixels will depend on the target field of view. Diffuser 22 can be made of any optically transparent material.

Positioned adjacent diffuser 22 is a lens assembly 24 for forming and further steering light generated by laser-based scanners 12 and redirected through diffuser 22. As previously discussed, lens assembly 24 can include an input end 26 for receiving output light emerging from diffuser 22, an output end 28 forming a second exit pupil 30 having a second exit pupil size of about 3 to about 3.5 millimeters, and one or more optical lenses 24a-e positioned between input end 26 and output end 28. The size of second exit pupil 30 being about 3.5 millimeters more closely approximates the size of the entrance pupil of the average human eye and, thereby, helps to overcome the pupil replication problem associated with significantly smaller exit pupils.

Lens assembly 24 performs two primary functions. First, it converts light emerging from each pixel/secondary point source on diffuser 22 which initially propagate as essentially spherical waves received at the input end of lens assembly 24, into collimated plane waves exiting from output end 28 of lens assembly 24, In the illustrated embodiment, where the field of view is about 50 degrees for example, the light beam exiting from the second exit pupil 30 can be a collimated beam, collimated to +/−20 degrees or more, but the degree of collimation of the output beam will need to be increased to achieve larger fields of view. Second, in addition to converting the spherical waves to collimated plane waves, lens system 24 also further steers the light emerging from each pixel/secondary point source on diffuser 22 so that the resulting beam collimated plane waves projects across substantially the entire cross-sectional area of the second exit pupil 30 located at output end 28 of lens assembly 24. The specific number and geometries of each of the discrete optical lenses 24a-e are selected to achieve the aforementioned functions.

In one embodiment, lenses 24a-e can be aspherical or free-form lenses made of plastic, which can significantly reduce the overall size, weight and cost of lens assembly 24. The free-form or aspheric nature of lenses 24a-e also allows the lens geometries to be fabricated to achieve the desired results while at the same time reducing the overall size of exit pupil expander 14. For example, free-form or aspherical lenses are particularly suited to modify or correct various geometrical distortions. This allows a greater degree of flexibility for lenses 24a-d to be specifically tailored to satisfy the geometries needed to insure that light emitted from each pixel/secondary point source of diffuser 22 is correctly steered and projected over substantially the entire cross-sectional area of second exit pupil 30.

Another advantage of using free-form or aspheric lenses is that it achieves a much smaller back focal length for lens assembly 24. This, in turn, allows lens 24a to be placed much closer to the intermediate image plane 18 than other systems found in the prior art. In the illustrated embodiment, back focal length of lens assembly 24 (i.e., the distance between intermediate image plane 18 and lens 24a) is about 100 microns or less. Similarly, the use of free-form or aspherical lenses also makes it possible to achieve the desired optical properties with a much shorter overall track length (i.e., the distance between intermediate image plane 18 and second exit pupil 30) than other systems found in the prior art and is generally in the range of about 8 to about 15 millimeters. In the illustrated embodiment, the track length of exit pupil expander 14 is only about 8.7 millimeters in length. This compact form-factor represents a significant improvement over what currently exists in the art.

As mentioned above, lenses 24a-e can consist of free-form lenses made of plastic. In one embodiment, lenses 24a-e can have the following physical and optical properties.

Exit pupil expander 14 as disclosed herein make it possible to achieve fields of view not previously attainable with laser-scanner and waveguide based augmented-reality displays. For example, based on the teachings set forth above, it is possible to achieve a field of view of about 100 degrees or more. More specifically, set forth below is a set of exemplary design parameters applicable from the intermediate image plan to the exit pupil.

FOV=from about 60 to about 100 degrees

P=Exit Pupil Size=about 3 millimeters

D=Diagonal Dimension of Intermediate Image Plane (from which also derives “virtual pixel pitch” for 1920×1440 resolution)

f=Focal Length of Lens=D/(2*tan(FOV/2))

Fₙₒ=Relative Aperture=f/P

To further illustrate these principles, set forth in the table below are several examples based on the foregoing design parameters.

| | Example | Example | Example | Example | Example | Example |
|---|---|---|---|---|---|---|
| | System 1 | System 2 | System 3 | System 4 | System 5 | System 6 |
| FOV (degrees) | 60 | 100 | 60 | 100 | 60 | 100 |
| P (Exit Pupil in mm) | 3 | 3 | 3 | 3 | 3 | 3 |
| D (Sensor Size in mm) | 6 | 6 | 8 | 8 | 10 | 10 |
| Virtual Pixel Pitch | 2.5 | 2.5 | 3.33 | 3.33 | 4.17 | 4.17 |
| (for 1920 × 1440 in μm) | | | | | | |
| f (Focal Length in mm) | 5.2 | 2.5 | 6.9 | 3.4 | 8.7 | 4.2 |
| Fₙₒ (Relative Aperture) | 1.7 | 0.8 | 2.3 | 1.1 | 2.9 | 1.4 |

The foregoing examples also illustrate the design challenges associated with these applications; the smaller the virtual pixel pitch and/or relative aperture values, the more challenging becomes the design of the optical system. It should also be noted that the foregoing examples are limited to the situation in which the resolution and pixel pitch are fixed. However, it may also be advantageous to keep angular resolution relatively constant, in which event the resolution and pixel pitch will necessarily increase as the field of view increases. For example, whereas about 2,000 pixels may be sufficient for a field of view of about 60 degrees, roughly about 4,000 pixels may be required for a field of view of about 100 degrees.

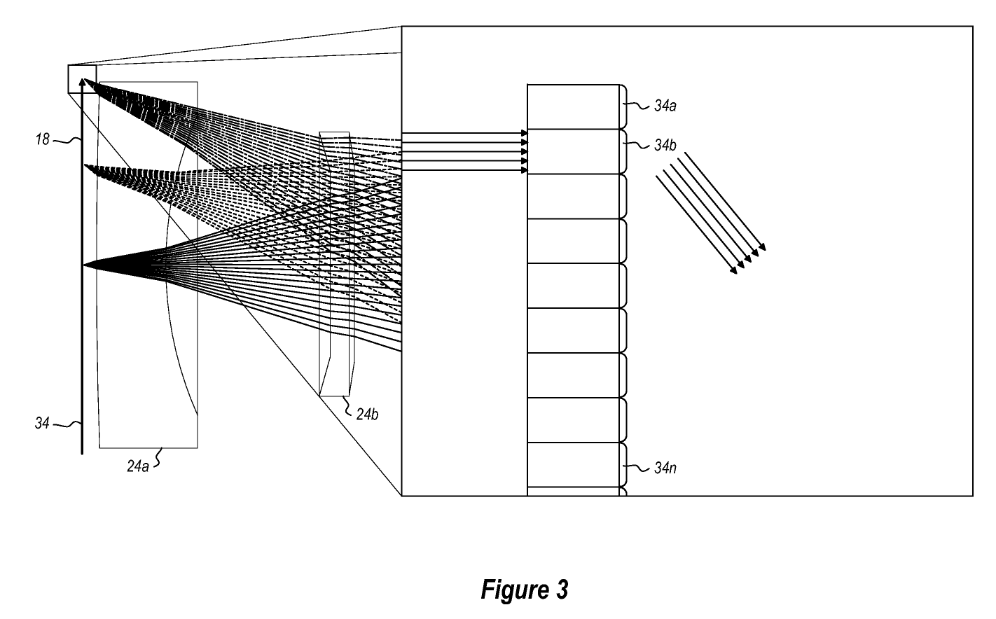

In another embodiment illustrated in FIG. 3, diffuser 22 may comprise a micro-lens array 34. In particular, FIG. 3 schematically illustrates an enlarged portion of a second embodiment of diffuser 22 being made up of a plurality of micro-lenses 34a-n positioned on top of a fiber optic faceplate. The fiber optic faceplate could be, for example, about 0.1 millimeters thick having individual channels with a predetermined pitch of virtual pixels. As previously discussed, the geometry and optical properties of each such micro-lens is selected so as to steer light received by and then transmitted by each such micro-lens at the proper exit angle and conical angle as to project the output beam across substantially the entire cross-sectional area of second exit pupil 30 (not shown in FIG. 3). The surface profile and surface offset of the micro-lens array can be selected to direct the light in the desired manner. For example, a surface profile for the micro-lens having a curvature of from about 13 to about 133 micrometers gives a significant light spread. Of course, the amount of light spread should be optimized for the projecting lens numerical aperture. In addition, micro-lens array can also include structures to reduce or eliminate cross-talk between adjacent pixels/micro-lenses.

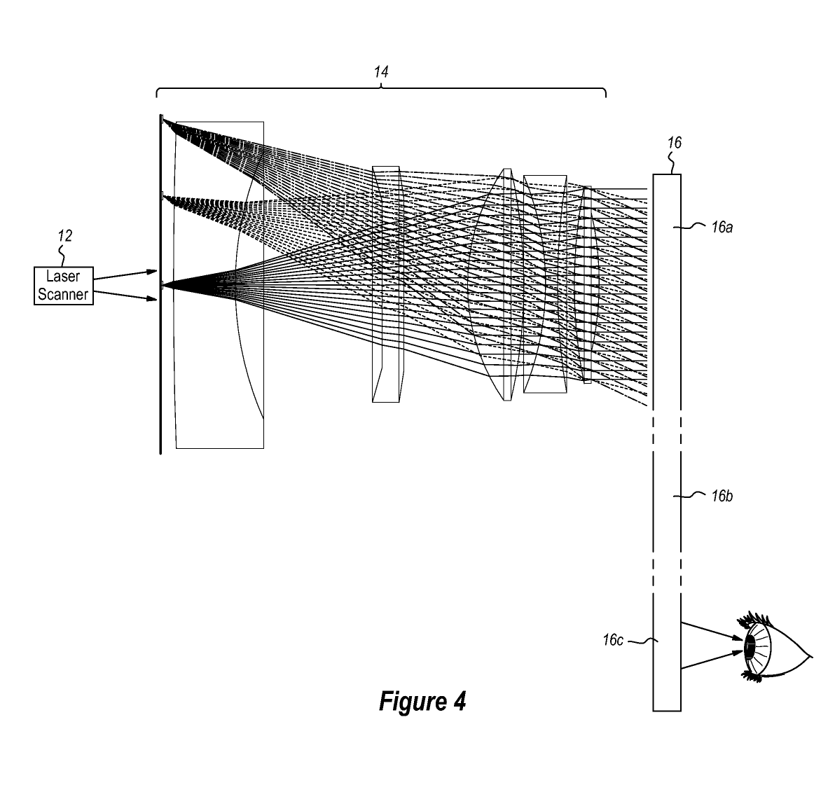

Now referring to FIG. 4, the output of lens assembly 24 can then act as the input to a waveguide plate or stack 16. The waveguide stack of plate 16 typically includes an in-coupling region 16a, a waveguide region 16b and an out-coupling area 16c, Light exiting from the second exit pupil 30 impinges on in-coupling region 16a and is coupled into the waveguide substrate, typically by an input grating (not shown) formed in the substrate at in-coupling region 16a. The in-coupled light propagates via total internal reflection along the waveguide region 16b. Then, the out-coupling region 16c can diffract the output beam towards the eye of an observer.

The following discussion now refers to a methods and a number of method acts that may be performed, Although the method acts may be discussed in a certain order or illustrated in a flow chart as occurring in a particular order, no particular ordering is required unless specifically stated, or required because an act is dependent on another act being completed prior to the act being performed.

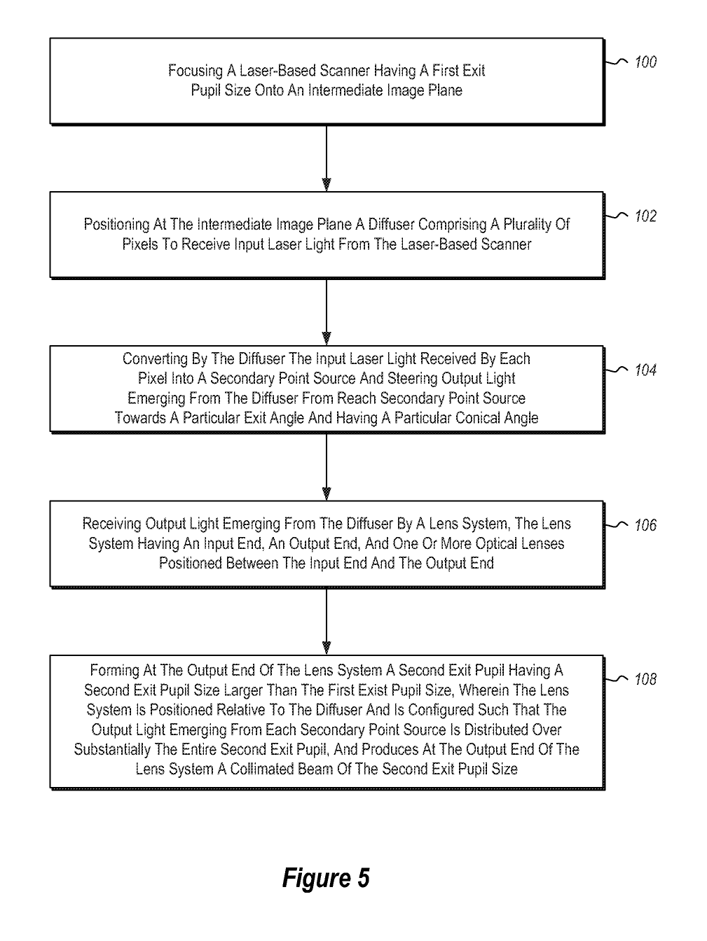

Referring to FIG. 5, a method for increasing the exit pupil of a laser-scanner and waveguide based display begins at 100 with an act of focusing a laser-based scanner having a first exit pupil size onto an intermediate image plane. As indicated at 102, the method can also include an act of positioning at the intermediate image plane a diffuser comprising a plurality of pixels to receive input laser light from the laser-based scanner. As indicated at 104, the method can also include an act of converting by the diffuser the input laser light received by each pixel into a secondary point source and steering output light emerging from the diffuser from each secondary point source towards a particular exit angle and having a particular conical angle. As indicated at 106, the method can also include an act of receiving output light emerging from the diffuser by a lens assembly, the lens assembly having an input end, an output end, and one or more optical lenses positioned between the input end and the output end. And, as indicated at 108, the method can also include an act of forming at the output end of the lens assembly a second exit pupil having a second exit pupil size larger than the first exit pupil size, wherein the lens assembly is positioned relative to the diffuser and is configured such that the output light emerging from each secondary point source is distributed over substantially the entire second exit pupil, and produces at the output end of the lens assembly a collimated beam of the second exit pupil size.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An optical display apparatus for laser-scanner and waveguide based displays configured to increase the exit pupil of the optical display apparatus, the apparatus comprising:
a laser-based scanner having a first exit pupil size, wherein the laser-based scanner is focused onto an intermediate image plane;
a diffuser positioned at the intermediate image plane, the diffuser comprising a plurality of pixels to receive input laser light from the laser-based scanner, wherein each pixel converts the input laser light received by that pixel into a secondary point source and steers output light emerging from the diffuser from each secondary point source towards a particular exit angle and having a particular conical angle; and
a lens assembly for forming light generated by the laser-based scanner, the lens assembly having an input end for receiving output light emerging from the diffuser, an output end forming a second exit pupil having a second exit pupil size larger than the first exit pupil size, and one or more optical lenses positioned between the input end and the output end, and
wherein the lens assembly is positioned relative to the diffuser and is configured such that the output light emerging from each secondary point source is distributed over substantially the entire second exit pupil, and produces at the output end of the lens assembly a collimated beam of the second exit pupil size.

2. An optical display apparatus as recited in claim 1, wherein the diffuser comprises a diffuser screen.

3. An optical display apparatus as recited in claim 1, wherein the diffuser comprises a micro-lens array.

4. An optical display apparatus as recited in claim 2, wherein the micro-lens array further comprises structures to reduce or eliminate cross-talk between adjacent pixels.

5. An optical display apparatus as recited in claim 1, wherein the one or more optical lenses of the lens assembly comprise one or plastic lenses.

6. An optical display apparatus as recited in claim 1, wherein the one or more optical lenses of the lens assembly comprise one or more aspheric, free-form lenses.

7. An optical display apparatus as recited in claim 1, wherein the lens assembly has a back focal length of 100 microns or less.

8. An optical display apparatus as recited in claim 1, wherein a track length of the lens assembly is about 15 millimeters or less.

9. An optical display apparatus as recited in claim 1, wherein the first exit pupil size is about 0.5 to about 2 millimeters.

10. An optical display apparatus as recited in claim 1, wherein the second exit pupil size is about 3 millimeters.

11. An optical display apparatus as recited in claim 1, wherein the intermediate image plane is about 5 to about 10 millimeters in size.

12. An optical display apparatus as recited in claim 10, wherein the diffuser includes about 2,000 pixels diagonally.

13. An optical display apparatus as recited in claim 11, wherein each pixel is about 3 microns in size.

14. An optical display apparatus as recited in claim 1, wherein collimated beam is collimated to plus and minus 20 degrees or more.

15. An optical display apparatus as recited in claim 1, wherein the optical display apparatus provides a field of view of about 50 degrees.

16. An optical display apparatus as recited in claim 1, wherein the optical display apparatus provides a field of view of about 100 degrees or more.

17. An optical display apparatus as recited in claim 1 further comprising a waveguide plate having an in-coupling region positioned adjacent to the output end of the lens assembly for receiving the collimated beam exiting from the lens assembly.

18. In an optical display apparatus for laser-scanner and waveguide based displays including a laser-based scanner having a first exit pupil size, an apparatus for increasing the exit pupil of the optical display apparatus, the apparatus comprising:
a micro-lens array positioned at an intermediate image plane, the micro-lens array comprising a plurality of pixels to receive input laser light from the laser-based scanner, wherein each pixel converts the input laser light received by that pixel into a secondary point source and steers output light emerging from the micro-lens array from each secondary point source towards a particular exit angle and having a particular conical angle; and
a lens assembly for forming light generated by the laser-based scanner, the lens assembly having an input end for receiving output light emerging from the micro-lens array, an output end forming a second exit pupil having a second exit pupil size larger than the first exit pupil size, and one or more optical lenses positioned between the input end and the output end, and wherein the lens assembly is positioned relative to the micro-lens array and is configured such that the output light emerging from each secondary point source is distributed over substantially the entire second exit pupil, and produces at the output end of the lens assembly a collimated beam of the second exit pupil size.

19. The optical display apparatus of claim 18, wherein the micro-lens array comprises a fiber optic faceplate with a thickness of about 0.1 millimeter and has a surface profile having a curvature of about 3.3 to about 3.33 micrometers.

20. A method for increasing the exit pupil of a laser-scanner and waveguide based display, the method comprising the acts of:
focusing a laser-based scanner having a first exit pupil size onto an intermediate image plane;
positioning at the intermediate image plane a diffuser comprising a plurality of pixels to receive input laser light from the laser-based scanner;
converting by the diffuser the input laser light received by each pixel into a secondary point source and steering output light emerging from the diffuser from each secondary point source towards a particular exit angle and having a particular conical angle; and
receiving output light emerging from the diffuser by a lens assembly, the lens assembly having an input end, an output end, and one or more optical lenses positioned between the input end and the output end;
forming at the output end of the lens assembly a second exit pupil having a second exit pupil size larger than the first exist pupil size,
wherein the lens assembly is positioned relative to the diffuser and is configured such that the output light emerging from each secondary point source is distributed over substantially the entire second exit pupil, and produces at the output end of the lens assembly a collimated beam of the second exit pupil size.
